(19) United States
(12) Patent Application Publication
(10) Pub. No.: US 2005/0121420 A1
(43) Pub. Date: Jun. 9, 2005

(54) Electric welder, electrode and method of use thereof for spot-weld tacking eutectic solder to thin film depositions on non-conductive substrates

(76) Inventor: Tad Janicki, Port Chester, NY (US)

Correspondence Address: GORDON-LENDVAY PATENT AGENCY, P O BOX 101, WHITE PLAINS, NY, 10605, US

(21) Appl. No.: 10/730,312

(22) Filed: Dec. 5, 2003

(51) Int. Cl. B23K 11/10

(52) U.S. Cl. 219/86.9; 219/113

(57) ABSTRACT

An electric welder for spot fusing a eutectic solder matching a thin film deposition on an electrically non-conductive substrate. An example being a gold-tin solder fusing to a gold plated ceramic or glass surface. At least one pair of laterally displaced electrodes is resiliently engaged with the surface of the eutectic. The electrodes are tapered at the terminus to restrict the area of current flow. The engaging tip of the electrode is rounded tangentially to the taper and very slightly penetrates the surface of the eutectic. Once engaged the electrode pair is pulsed with sufficient current, from for example a capacitor discharge circuit, to create a local heat cone at the contact point sufficient to reach the eutectic point thereby locally fusing the eutectic to the plating.

### FIELD OF THE INVENTION

The present invention relates to apparatus and methods for electric welding. More specifically, the present invention relates to methods and apparatus for electric spot-welding multiple spots from one face of a heat sensitive material. Even more specifically, the present invention relates to methods and apparatus for spot-welding multiple spots from one face thereby tacking a heat-fusible conductive sheet to a thin-film conductive layer on an electrically non-conductive heat-tolerant substrate.

### BACKGROUND

Using a variety of techniques such as vapor deposition, sputter coating, photolithography, electroplating, etc., articles made of non-conductive materials, such as glass or ceramic, are increasingly produced with swig of one or more very thin metal layers. These thin film layers, purposed as electrical conductors, heat conductors, nucleation substrates for continued electroplating, etc., can also be used as anchorage substrates in a eutectic bonding operation.

For example of such a use, referring to FIG. 1, it is conventional to hermetically seal an IC semiconductor chip (not Shown) in a cavity 3 of a ceramic package 1. Such is disclosed in U.S. Pat. No. 3,946,190 to Hascoe for a “Method of Fabricating a Sealing Cover for an Hermetically Sealed Container,” the entirety of which is incorporated herein by reference. To make the seal a frame 7 of a eutectic solder such as gold-tin is sandwiched between a metal lid 2 and a gold plated ledge 6 within an indentation 5 in a package body 4. The expensive gold based eutectic forming frame 7 is often brittle and frame 7 is of very small dimensions to conserve material. Consequently frame 7 is delicate and difficult to handle. Assembly and ration is improved by first tacking frame 7 to metal lid 2 using multiple spot welds. Then placing the lid-frame subassembly onto package body 4 in indentation 5 and heating the assembly to fuse frame 7 to lid 2 and ledge 6; thereby forming a hermetic seal between lid 2 and package body 4.

To improve thermal conductivity properties, the industry began moving away from a metal lid 2 and began using a ceramic lid 2′ that was made of an electrically non-conductive material. Although ceramic lid 2′ can be formed with a thin-film deposit of gold on the mating surface matching frame 7, the spot welding electrode arrays and methods used to tack frame 7 to metal lid 2 cannot spot weld frame 7 to ceramic lid 2′.

Since the industry is moving in the direction of utilizing ceramic lids in place of metal, it would be an important advance to have an apparatus and/or method for tacking a eutectic gold-tin frame material to the thin gold plating on the undersurface of a semiconductor package lid. In this regard it would be desirable to provide a method and apparatus for spot-welding a eutectic material to a thin-film on a non-conductive substrate.

### OBJECTS AND SUMMARY OF THE INVENTION

It is an object of the present invention to overcome the problems of the prior art by providing a method and apparatus for spot-welding a eutectic material to a thin-film on a nonconductive substrate.

According to an embodiment of the invention, there is provided an electric welder for spot fusing a eutectic metal to a thin film electrical conductor on an electrically non-conductive substrate, including; at least one pair of an electrode, at least one the electrode having a terminal end that is tapered tangentially to a domed terminus, and the domed terminus having a radius sufficiently small to concentrate an electrical current to produce a heat cone and penetrate the eutectic metal and sufficiently large to prevent an intolerable damage to any of the eutectic metal, the thin film, and the substrate.

According to a feature of the invention, there is provided, for the above welder, that the substrate is a lid for an IC package made of ceramic or glass, the thin film is made substantially of gold, and the eutectic metal is a frame therefore made substantially of an alloy of 80% gold and 20% tin, and each the electrode is made of and alloy of copper tungsten.

According to a feature of the invention, there is provided, for the above welder, that the spot fusing is accomplished by pulsing the electrical current from a discharging capacitor through the electrode pair.

According to an embodiment of the invention, there is provided a method of using the welder for spot fusing a eutectic metal to a thin film electrical conductor on an electrically non-conductive substrate, including; placing the eutectic metal in registration contact with the thin film, pressing a pressure block against the eutectic metal, pressing at least one of the electrode pair of the welder into contact with the eutectic metal under sufficient pressure to displace a tiny bit of the eutectic metal against the thin film, pulsing an electrical current through the electrode pair of sufficient energy to cause a localized heating and melting of the eutectic metal, allowing the eutectic metal to cool and thereby solidify, and removing the electrode pair and the pressure block therefrom.

Briefly stated, the present invention includes an electric welder for spot fusing a eutectic solder matching a thin film deposition on an electrically non-conductive substrate. An example being a gold-tin solder fusing to a gold plated ceramic or glass surface. At least one pair of laterally displaced electrodes is resiliently engaged with the surface of the eutectic. The electrodes are tapered at the terminus to restrict the area of current flow. The engaging tip of the electrode is rounded tangentially to the taper and very slightly penetrates the surface of the eutectic. Once engaged the electrode pair is pulsed with sufficient current, from for example a capacitor discharge circuit, to create a local heat cone at the contact point sufficient to reach the eutectic point thereby locally fusing the eutectic to the plating.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a perspective view of an IC semiconductor chip package with the lid placement illustrated

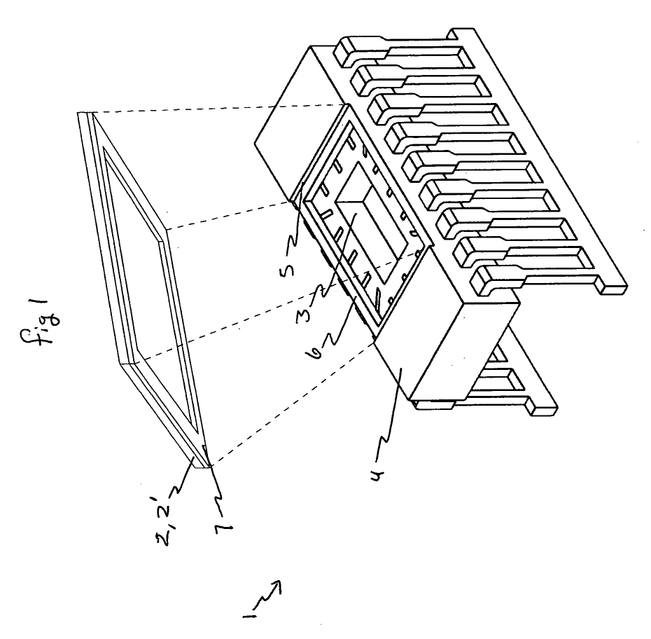

FIG. 2 is a perspective view of an electrode array portion of an embodiment of the present invention used to spot weld the four corners of a frame of weld material to a thin metal film on the underside of a ceramic IC packaging Lid.

FIG. 3 is a perspective view of an electrode array portion of an embodiment of the present invention with an inset detailing the positioning of one electrode.

FIG. 4 is a longitudinal cross section of the tip of the electrode of an embodiment of the present invention demonstrating the terminal portion shape thereof.

FIG. 5 is a longitudinal cross section of the tip of the electrode of an embodiment of the present invention demonstrating the positioning of one electrode in conjunction with the work pieces and detailing some typical dimensions in the art instant thereto.

FIG. 6 is a longitudinal cross section of an electrode array portion of an embodiment of the present invention with an inset detailing the presence of the heat cone resulting from a firing of the electrodes.

### DETAILED DESCRIPTION OF THE PREFERRED EMBODIMENT(S)

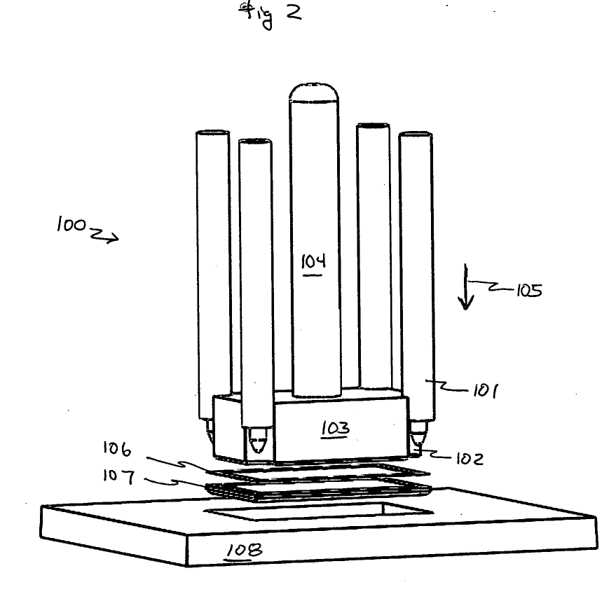

Referring to FIG. 2, an embodiment of an electrode array head 100 of a capacitor discharge spot welder includes four electrodes 101 slidably embedded in an electrode channel through an electrode block (Not Shown) and protrudable through a guide channel 102 in a pressure block 103. Pressure block 103 has a push rod 104 attached thereto that is likewise slidably embedded in a central channel (also Not Shown) in the electrode block. Springs (also Not Shown), within the electrode channels and the central channel bias electrodes 101 and pressure block 103 in the direction of arrow 105.

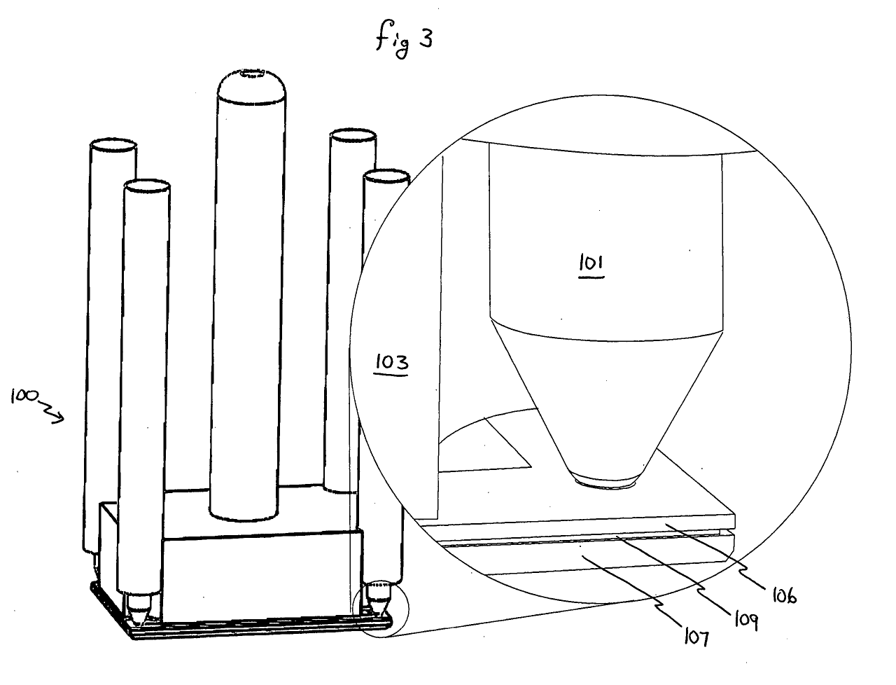

In this embodiment, the electrode array's intended use is to tack a frame 106 of eutectic solder to a thin metal film disposed on the undersurface of an IC package lid 107. A pod 108 aligns frame 106 laterally with lid 107 while electrode array head 100 advances. Referring to FIG. 3 in the context of FIG. 2, (pod 108 is removed for clarity and frame 106 is shown in contact with a thin metal film 109 on lid 107) electrode array head 100 has advanced far enough toward pod 108 to activate the pressure from the spring therein such that pressure block 103 is pressing against frame 106 stabilizing its position contacting lid 107. Also, each electrode 101 has contacted a corner of frame 106 with enough pressure from the springs to cause a very tiny indentation therein.

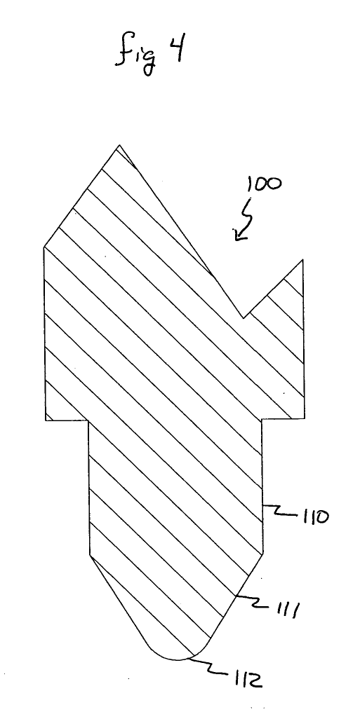

Referring to FIG. 4 in the context of FIGS. 2 & 3, a longitudinal section of the tip of electrode 100, demonstrating the terminal portion shape thereof has a straight cylindrical mass portion 110, leading to a tapered portion 111 that terminates tangentially with a curved dome portion 112. The amount of taper for tapered portion 111 and the radius of curvature of dome portion 112 are determined empirically to satisfy the conditions of the welding operation. The goal is to have a very small surface penetration by dome portion 112 without causing undue damage to frame 106, thin film 109, or lid 107. If dome portion 112 is small or has a small radius electrode tip 100 will penetrate too far into frame 106. At the least this would cause a flaw in the surface and at the worst cause frame 107 and or lid 17 to crack or break. on the other hand a large shallow dome portion results I lack of penetration and inability to form the weld.

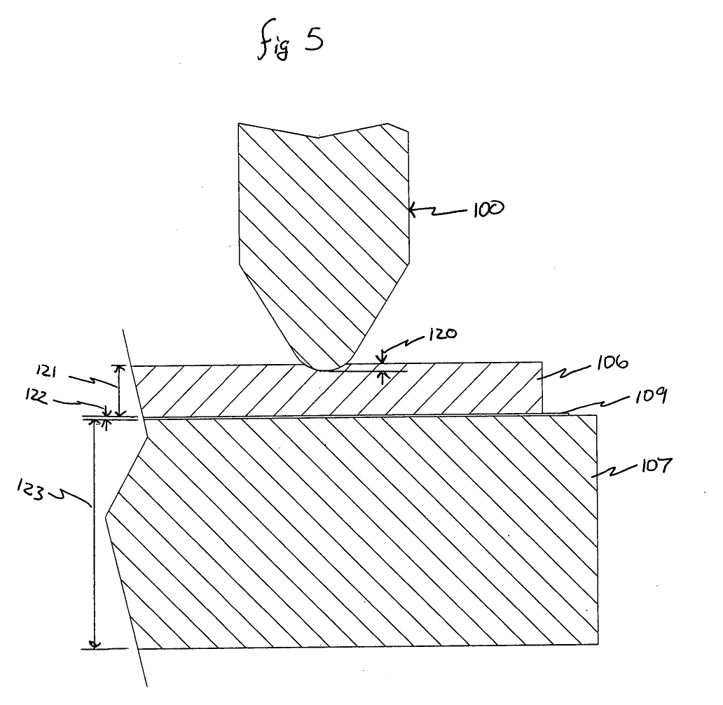

Referring to FIG. 5, an example of a typical cross section of lid 107, thin film 109, frame 106 and electrode 100 arranged for welding with electrode 100 penetrating frame 106 a depth 120. In this example depth 120 is approximately 0.0004″, ⅕ the thickness 121 of frame 106 which is 0.0018″-0.0020″. Thickness 122, the dimensional thickness of thin film 109, is very thin at 0.000020″ and thickness 123, the dimensional thickness of lid 107, is 0.01″.

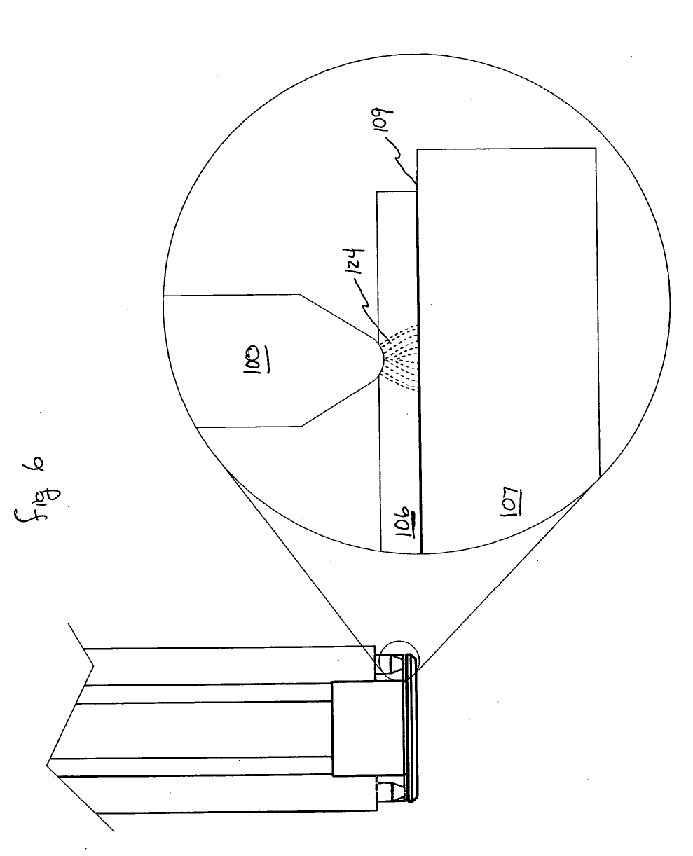

Referring to FIG. 6, since lid 107 is an electrically non-conductive substrate current flow between the electrode 100 pairs is laterally directed through thin film 109 and flame 106. The tapered shape of electrode 100, at the terminus ending at an interior point in flame 106, concentrates the current flow to a very small area resulting in a heat cone 124 at each electrode. Heat cone 124 is sufficient to locally fuse the eutectic metal of frame 106 with thin film 109.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims. For example it is considered within the scope of the invention to substitute other eutectic solder/metal matched combinations in place of the gold-tin eutectic/gold. Such metals as silver, palladium, lead, copper, platinum, etc and their eutectic match could be substituted for the gold.

1. An electric welder for spot fusing a eutectic metal to a thin film electrical conductor on an electrically non-conductive substrate, comprising:
at least one pair of an electrode, at least one said electrode having a terminal end that is tapered tangentially to a domed terminus; and
said domed terminus having a radius sufficiently small to concentrate an electrical current to produce a heat cone and penetrate said eutectic metal and sufficiently large to prevent an intolerable damage to any of said eutectic metal, said thin film, and said substrate.

2. The welder of claim 1, wherein:
said substrate is a lid for an IC package made of ceramic or glass, said thin film is made substantially of gold, and said eutectic metal is a frame therefore made substantially of an alloy of 80% gold and 20% tin; and
each said electrode is made of and alloy of copper tungsten.

3. The welder of claim 1, wherein, said spot fusing is accomplished by pulsing said electrical current from a discharging capacitor through said electrode pair.

4. A method of using the welder of claim 1 for spot fusing a eutectic metal to a thin film electrical conductor on an electrically non-conductive substrate, comprising:
placing said eutectic metal in registration contact with said thin film;
pressing a pressure block against said eutectic metal;
pressing at least one of said electrode pair of the welder of claim 1 into contact with said eutectic metal under sufficient pressure to displace a tiny bit of said eutectic metal against said thin film,
pulsing an electrical current through said electrode pair of sufficient energy to cause a localized heating and melting of said eutectic metal;
allowing said eutectic metal to cool and thereby solidify, and
removing said electrode pair and said pressure block therefrom.
